(19) United States
(12) Patent Application Publication
(10) Pub. No.: US 2017/0079317 A1
(43) Pub. Date: Mar. 23, 2017

(54) HIGHLY SOLUBLE STEVIOL GLYCOSIDES

(71) Applicant: CARGILL, INCORPORATED, Wayzata, MN (US)

(72) Inventors: Ting Liu Carlson, Marietta, SC (US); Melanie Jean Goulson, Dayton, MN (US); Nathan Edward Knutson, Maple Grove, MN (US)

(73) Assignee: CARGILL, INCORPORATED, Wayzata, MN (US)

(21) Appl. No.: 15/310,614

(22) PCT Filed: May 13, 2015
(86) PCT No.: PCT/US15/30538

§ 371 Date: Nov. 11, 2016

Related U.S. Application Data
(60) Provisional application No. 61/992,540, filed on May 13, 2014.

(51) Int. Cl. A23L 27/30; A23L 2/60

(52) U.S. Cl. CPC A23L 27/33; A23L 2/60; A23L 27/36; A23V 2002/00

(57) ABSTRACT

The present invention provides a liquid composition comprising one or more steviol glycosides, wherein the one or more steviol glycosides comprise Rebaudioside O. The present invention also provides a method of making a liquid composition comprising one or more steviol glycosides, wherein the one or more steviol glycosides comprise Rebaudioside O. The liquid compositions are useful for applications such as beverages, carbonated beverages, concentrates, beverage concentrates, throw syrups, or portable liquid concentrate tabletop applications.

### CROSS-REFERENCE TO RELATED APPLICATIONS

This application claims the benefit of U.S. Provisional Patent Application Ser. No. 61/992,540, filed on May 13, 2014, entitled HIGHLY SOLUBLE STEVIOL GLYCOSIDES, which application is hereby incorporated by reference herein in its entirety.

### FIELD OF THE INVENTION

The present invention relates to compositions comprising soluble steviol glycosides. More specifically, the present invention relates to liquid compositions including highly soluble minor steviol glycosides such as rebaudioside O.

### BACKGROUND OF THE INVENTION

Sugar alternatives are highly sought after for use in various food and beverage products. Steviol glycosides are sweet-tasting compounds extracted from the stevia plant (Stevia rebaudiana Bertoni). Known sweet glycosides that may be extracted from Stevia include, for example, the six rebaudiosides, Rebaudioside A to F, stevioside, and dulcoside A. In particular, significant commercial interest has been focused on obtaining and purifying Rebaudioside A from Stevia. Other minor steviol glycosides that have also been isolated from Stevia having pleasant-tasting sweet characteristics include, but are not limited to, rebaudioside O.

The structures and characteristics of various minor steviol glycosides, including Rebaudioside O, are reported by Morita et al. in US Pub No 2011/0183056 and by Chaturvedula et al. in Biomolecules, 2013, 3, 733-740.

### SUMMARY OF THE INVENTION

The present invention is directed to, in part, liquid compositions that comprise one or more soluble steviol glycosides.

In one embodiment, a liquid composition comprises one or more steviol glycosides, wherein the concentration of the one or more steviol glycosides in the composition comprises at least 0.1 wt % of the composition, and wherein the one or more steviol glycosides comprise Rebaudioside O.

In some embodiments of the invention, the concentration of the one or more steviol glycosides in the composition comprises at least 0.5 wt % of the composition, at least 1 wt % of the composition, or at least 5 wt % of the composition.

In other embodiments, the concentration of the one or more steviol glycosides comprises 0.1-10 wt % of the composition, the concentration of the one or more steviol glycosides comprises 0.5-10 wt % of the composition, or the concentration of the one or more steviol glycosides comprises 1-10 wt % of the composition.

In still other embodiments, the one or more steviol glycosides comprises 1-95 wt % Rebaudioside O, the one or more steviol glycosides comprises 5-75 wt % Rebaudioside O, the one or more steviol glycosides comprises 10-55 wt % Rebaudioside O, the one or more steviol glycosides comprises 15-35 wt % Rebaudioside O, or the one or more steviol glycosides comprises 1-15 wt % Rebaudioside O.

In other embodiments, the liquid composition comprises a beverage, a carbonated beverage, a concentrate, a beverage concentrate, or a portable liquid concentrate table top application.

Other embodiments of the invention include a method of making a liquid composition comprising the steps of providing one or more steviol glycosides wherein the one or more steviol glycosides comprise Rebaudioside O, and contacting the one of more steviol glycosides with a sufficient amount of a liquid comprising water to provide the liquid composition. In some embodiments of the method, the concentration of the one or more steviol glycosides in the composition comprises at least 5 wt % of the composition, the concentration of the one or more steviol glycosides is at least 1 wt % of the composition, the concentration of the one or more steviol glycosides is at least 0.5 wt % of the composition, or the concentration of the one or more steviol glycosides is at least 0.1 wt % of the composition.

In other embodiments of the method, the one or more steviol glycosides comprises 1-95 wt % Rebaudioside O, the one or more steviol glycosides comprises 5-75 wt % Rebaudioside O, the one or more steviol glycosides comprises 15-55 wt % Rebaudioside O, the one or more steviol glycosides comprises 10-35 wt % Rebaudioside O, or the one or more steviol glycosides comprises 1-15 wt % Rebaudioside O.

In still other embodiments, the method may be used to provide a beverage, a carbonated beverage, a concentrate, a beverage concentrate, a throw syrup, or a portable liquid concentrate tabletop application.

### DETAILED DESCRIPTION

The embodiments of the present invention described below are not intended to be exhaustive or to limit the invention to the precise forms disclosed in the following detailed description. The purpose of the embodiments chosen and described is to provide an appreciation and understanding by those skilled in the art of the principles and practices of the present invention.

The present invention is directed to, in part, liquid compositions that comprise one or more soluble steviol glycosides, wherein the one or more soluble steviol glycosides comprise Rebaudioside O. As seen in the example, Rebaudioside O (≧95% purity) has a measured instantaneous solubility in ultrapure water at ambient temperature of >50 g/L at both pH 7 and pH 3 (citrate buffer).

In some embodiments, the one or more steviol glycosides comprise Rebaudioside O. Other steviol glycosides may also be present such as, but not limited to, Rebaudioside A, Rebaudioside B, Rebaudioside C, Rebaudioside D, Rebaudioside F, steviol bioside, steviol monoside, stevioside, dulcoside A, rubososide, other minor steviol glycosides, or combinations thereof. In another embodiment, the one or more steviol glycoside is a combination of Rebaudioside A and Rebaudioside O.

In one embodiment of the invention, a liquid composition comprises one or more steviol glycosides, wherein the concentration of the one or more steviol glycosides in the composition comprises at least 0.1 wt % of the composition, and wherein the one or more steviol glycosides comprise Rebaudioside O.

In some embodiments, the concentration of the one or more steviol glycosides in the composition comprises at least 0.1 wt % of the composition, at least 0.3 wt % of the composition, at least 0.5 wt % of the composition, at least 0.7 wt % of the composition, at least 1 wt % of the composition, at least 2 wt % of the composition, at least 3 wt % of the composition, at least 4 wt % of the composition, or at least 5 wt % of the composition.

In other embodiments, the concentration of the one or more steviol glycosides comprises 1-30 wt % of the composition, the concentration of the one or more steviol glycosides comprises 1-25 wt % of the composition, the concentration of the one or more steviol glycosides comprises 1-20 wt % of the composition, the concentration of the one or more steviol glycosides comprises 1-15 wt % of the composition, the concentration of the one or more steviol glycosides comprises 1-10 wt % of the composition, the concentration of the one or more steviol glycosides comprises 2-20 wt % of the composition, the concentration of the one or more steviol glycosides comprises 2-15 wt % of the composition, the concentration of the one or more steviol glycosides comprises 2-10 wt %/o of the composition the concentration of the one or more steviol glycosides comprises 2-8 wt % of the composition, the concentration of the one or more steviol glycosides comprises 2-6 wt % of the composition, the concentration of the one or more steviol glycosides comprises 2-5 wt % of the composition, the concentration of the one or more steviol glycosides comprises 3-15 wt % of the composition, the concentration of the one or more steviol glycosides comprises 3-10 wt % of the composition the concentration of the one or more steviol glycosides comprises 3-8 wt % of the composition, the concentration of the one or more steviol glycosides comprises 3-6 wt % of the composition, or the concentration of the one or more steviol glycosides comprises 3-5 wt % of the composition.

In still other embodiments, the one or more steviol glycosides comprises 1-95 wt % Rebaudioside O, the one or more steviol glycosides comprises 5-95 wt % Rebaudioside 0, the one or more steviol glycosides comprises 10-95 wt % Rebaudioside O, the one or more steviol glycosides comprises 5-75 wt % Rebaudioside O, the one or more steviol glycosides comprises 10-55 wt % Rebaudioside O, the one or more steviol glycosides comprises 15-50 wt % Rebaudioside O, the one or more steviol glycosides comprises 15-35 wt % Rebaudioside O, the one or more steviol glycosides comprises 5-25 wt % Rebaudioside O, or the one or more steviol glycosides comprises 1-15 wt % Rebaudioside O.

In yet other embodiments, the one or more steviol glycosides comprises at least 1 wt % Rebaudioside O, at least 5 wt % Rebaudioside O, at least 10 wt % Rebaudioside O, at least 20 wt %/o Rebaudioside O, at least 40 wt % Rebaudioside O, at least 70 wt % Rebaudioside O, at least 90 wt % Rebaudioside O, or at least 95 wt % Rebaudioside O.

In some embodiments, the pH of the liquid composition is less than 8. In other embodiments, the pH of the liquid composition is less than 7. In yet other embodiments, the pH of the liquid composition is less than 6. In yet other embodiments, the pH of the liquid composition is less than 5. In yet other embodiments, the pH of the liquid composition is less than 4. In yet other embodiments, the pH of the liquid composition ranges from 2 to 5. In yet other embodiments, the pH of the liquid composition ranges from 2 to 4.

In other embodiments, the liquid composition comprises a beverage, a carbonated beverage, a concentrate, a beverage concentrate, or a portable liquid concentrate table top application. Examples of beverages include carbonated soft drinks, ready to drink teas, sports drinks, dairy drinks, yogurt-containing drinks, alcoholic beverages, energy drinks, flavored waters, vitamin drinks, fruit drinks, and fruit juices.

In embodiments where the liquid composition is a beverage, a carbonated beverage or a beverage concentrate, the liquid composition may also include additional ingredients, such as flavorants, preservatives, emulsifiers, colorants, nutritive sweeteners, high intensity sweeteners, vitamins, mineral salts, and clouding agents. In an embodiment, the flavorant is selected from the group consisting of lemon, lime, orange, grape, lemon-lime, cola, root beer, peach, kiwi, and mixtures thereof.

The liquid compositions of the present invention may also include other ingredients. In some embodiments, the liquid compositions can further include another high intensity sweetener, a flavoring, an antioxidant, caffeine, a nutritive sweetener, salts, protein, or a sweetness enhancer. Other optional additives that may be used in the present liquid composition include preservatives, other solvents such as glycerol and ethanol, or other polyols such as erythritol, sorbitol, or maltitol.

Optionally, the liquid composition contains one or more additional steviol glycosides. Examples of steviol glycosides include rebaudioside A, rebaudioside C, rebaudioside D, rebaudioside E, rebaudioside F, stevioside, rubusoside, steviolbioside, and dulcoside A, other steviol glycosides, and mixtures thereof. These additional steviol glycosides are optionally each present at a concentration of from about 10 to about 8000 ppm.

Other embodiments include a method of making a liquid composition comprising the steps of providing one or more steviol glycosides wherein the one or more steviol glycosides comprises Rebaudioside O, and contacting the one of more steviol glycosides with a sufficient amount of a liquid comprising water to provide the liquid composition as an aqueous composition. The term aqueous as used herein means that the liquid composition contains water. The liquid composition may be greater than 50% water, 75% water, or 90% water.

In some embodiments of the method, the concentration of the one or more steviol glycosides in the composition comprises at least 0.1 wt % of the composition, at least 0.3 wt % of the composition, at least 0.5 wt % of the composition, at least 0.7 wt % of the composition, at least 1 wt % of the composition, at least 2 wt % of the composition, at least 3 wt % of the composition, at least 4 wt % of the composition, or at least 5 wt % of the composition.

In other embodiments of the method, the concentration of the one or more steviol glycosides comprises 1-30 wt % of the composition, the concentration of the one or more steviol glycosides comprises 1-25 wt % of the composition, the concentration of the one or more steviol glycosides comprises 1-20 wt % of the composition, the concentration of the one or more steviol glycosides comprises 1-15 wt % of the composition, the concentration of the one or more steviol glycosides comprises 1-10 wt % of the composition, the concentration of the one or more steviol glycosides comprises 2-20 wt % of the composition, the concentration of the one or more steviol glycosides comprises 2-15 wt % of the composition, the concentration of the one or more steviol glycosides comprises 2-10 wt % of the composition the concentration of the one or more steviol glycosides comprises 2-8 wt % of the composition, the concentration of the one or more steviol glycosides comprises 2-6 wt % of the composition, the concentration of the one or more steviol glycosides comprises 2-5 wt % of the composition, the concentration of the one or more steviol glycosides comprises 3-15 wt % of the composition, the concentration of the one or more steviol glycosides comprises 3-10 wt % of the composition the concentration of the one or more steviol glycosides comprises 3-8 wt % of the composition, the concentration of the one or more steviol glycosides comprises 3-6 wt % of the composition, or the concentration of the one or more steviol glycosides comprises 3-5 wt % of the composition.

In yet other embodiments of the method, the one or more steviol glycosides comprises 1-95 wt %/o Rebaudioside O, the one or more steviol glycosides comprises 5-95 wt % Rebaudioside O, the one or more steviol glycosides comprises 10-95 wt % Rebaudioside O, the one or more steviol glycosides comprises 5-75 wt % Rebaudioside O, the one or more steviol glycosides comprises 10-55 wt % Rebaudioside O, the one or more steviol glycosides comprises 15-50 wt % Rebaudioside O, the one or more steviol glycosides comprises 15-35 wt % Rebaudioside O, the one or more steviol glycosides comprises 5-25 wt % Rebaudioside O, or the one or more steviol glycosides comprises 1-15 wt % Rebaudioside O.

In yet other embodiments of the method, the one or more steviol glycosides comprises at least 1 wt % Rebaudioside O, at least 5 wt % Rebaudioside O, at least 10 wt % Rebaudioside O, at least 20 wt % Rebaudioside O, at least 40 wt % Rebaudioside O, at least 70 wt % Rebaudioside O, at least 90 wt % Rebaudioside O, or at least 95 wt % Rebaudioside O.

In yet other embodiments of the method, the pH of the liquid composition is less than 8. In other embodiments, the pH of the liquid composition is less than 7. In yet other embodiments, the pH of the liquid composition is less than 6. In yet other embodiments, the pH of the liquid composition is less than 5. In yet other embodiments, the pH of the liquid composition is less than 4. In yet other embodiments, the pH of the liquid composition ranges from 2 to 5. In yet other embodiments, the pH of the liquid composition ranges from 2 to 4.

In still other embodiments, the method may be used to provide a beverage, a carbonated beverage, a concentrate, a beverage concentrate, a throw syrup, or a portable liquid concentrate tabletop application.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

### Example

Two solutions were prepared: one at pH 7 in ultrapure water and the other at pH 3 (0.01 M citric acid). A purified sample of rebaudioside O (295% purity) was added incrementally to reach a saturation concentration. Based on limited quantity of rebaudioside O, and observed high solubility, the solubility was determined to be greater than 50 g/L.

Solubility of Rebaudioside O in Acidic and Neutral Solution

| | Rebaudioside O solubility |
|---|---|
| pH of solution | (g/L) |
| pH 3 | >50 |
| pH 7 | >50 |

1. A liquid composition comprising one or more steviol glycosides, wherein:
a. the concentration of the one or more steviol glycosides in the composition comprises at least 0.1 wt % of the composition,
b. the one or more steviol glycosides comprise Rebaudioside O; and
c. the liquid composition is an aqueous composition.

2. The composition of claim 1, wherein the concentration of the one or more steviol glycosides in the composition comprises at least 1-10 wt % of the composition.

3. The composition of claim 1, wherein the concentration of the one or more steviol glycosides is at least 5 wt % of the composition.

4. The composition of claim 1, wherein the concentration of the one or more steviol glycosides comprises 2-6 wt % of the composition.

5. The composition of claim 1, wherein the one or more steviol glycosides comprises 1-95 wt % Rebaudioside O.

6. The composition of claim 1, wherein the one or more steviol glycosides comprises 15-50 wt % Rebaudioside O.

7. The composition of claim 1, wherein the pH of the composition is less than 5.

8. The composition of claim 1, wherein the pH of the composition ranges from 2 to 5.

9. The composition of claim 1, wherein the composition comprises a concentrate.

10. The composition of claim 1, wherein the composition comprises a throw syrup.

11. A method of making a liquid concentrate comprising the steps of providing one or more steviol glycosides wherein the one or more steviol glycosides comprise Rebaudioside O, and contacting the one of more steviol glycosides with a sufficient amount of a liquid comprising water to provide the liquid concentrate.

12. The method of claim 11, wherein the concentration of the one or more steviol glycosides is at least 5 wt % of the composition.

13. The method of claim 11, wherein the one or more steviol glycosides comprises 15-50 wt % Rebaudioside O.

14. The method of claim 11, wherein the concentrate comprises a beverage concentrate.

15. The method of claim 11, wherein the concentrate comprises a throw syrup.
